(19) United States
(12) Patent Application Publication
(10) Pub. No.: US 2022/0350112 A1
(43) Pub. Date: Nov. 3, 2022

(54) IMAGE PICKUP LENS

(71) Applicant: Tokyo Visionary Optics Co., Ltd., Tokyo (JP)

(72) Inventor: Masaki YAMAZAKI, Tokyo (JP)

(21) Appl. No.: 17/643,249

(22) Filed: Dec. 8, 2021

(30) Foreign Application Priority Data
Dec. 8, 2020 (JP) 2020-203717

(51) Int. Cl. G02B 9/64

(52) U.S. Cl. CPC G02B 9/64

(57) ABSTRACT

An imaging lens includes: arranged in order from an object side to an image side IM, a first lens L1 having positive refractive power; a second lens L2 having negative refractive power; a third lens L3 having positive refractive power; a fourth lens L4 having positive refractive power; a fifth lens L5; a sixth lens L6; a seventh lens L7 having negative refractive power; and an eighth lens L8 having negative refractive power, wherein an object-side surface of the sixth lens L6 is concave in a paraxial region, and an object-side surface of the eighth lens L8 is convex in the paraxial region.

The present invention relates to an imaging lens for forming an image of an object on an image sensor, such as a CCD sensor and a CMOS sensor.

With the development of IoT (Internet of Things) technology, portable information devices, such as smartphones and cellular phones, as well as many products and devices, such as game consoles, home appliances, and automobiles, are connected to networks, and various types of information are shared between these “Things”. In the IoT environment, various services are allowed to be provided using image information from cameras built in the “Things”. The image information transmitted through networks continuously increases every year and such a camera is expected to be compact and to have high resolution.

To obtain a high-resolution distinctive image, aberrations in an imaging lens built in the camera have to be satisfactorily corrected. A lens configuration including eight lenses has, due to the large number of lenses composing the imaging lens, a high degree of freedom in design and thus allows satisfactory correction of aberrations. Patent Document 1 discloses an imaging lens having such an eight-lens configuration.

The imaging lens described in Patent Document 1 includes: a first lens with positive refractive power; a second lens with negative refractive power; a third lens with positive refractive power; a fourth lens; a fifth lens; a sixth lens; a seventh lens; and a eighth lens with negative refractive power. In the imaging lens, the refractive power of the first lens is less than the refractive power of the entire optical system of the imaging lens in a certain range and the third lens has a shape limited to a specific shape defined by a curvature radius. In addition, the second lens has a thickness in a certain range relative to the distance between the second lens and the third lens to achieve satisfactory correction of aberrations.

Patent Document 1: Chinese Patent Application Publication No. 111007631

The above imaging lens described in Patent Document 1 allows relatively satisfactory correction of aberrations while providing a wide field of view. However, the resolution expected from the imaging lens increases every year, and considering adaptation of high resolution, the lens configuration described in Patent Document 1 causes insufficient correction of aberrations.

It is an object of the present invention to provide an imaging lens capable of satisfactorily correcting aberrations while achieving reduction in the profile of the imaging lens.

### SUMMARY OF THE INVENTION

An imaging lens according to the present invention for forming an image of an object on an image sensor includes: in order from an object side to an image side, a first lens having positive refractive power; a second lens having negative refractive power; a third lens having positive refractive power; a fourth lens having positive refractive power; a fifth lens; a sixth lens; a seventh lens having negative refractive power; and an eighth lens having negative refractive power. An object-side surface of the sixth lens is concave in a paraxial region, and an object-side surface of the eighth lens is convex in the paraxial region.

In the imaging lens according to the present invention, the second lens having negative refractive power is arranged on the image plane side of the first lens having positive refractive power. This allows satisfactory correction of chromatic aberration while preferably reducing the profile of the imaging lens. In addition, when the third lens and the fourth lens have positive refractive power, and the object-side surface of the eighth lens is convex in the paraxial region, it is thus possible to further reduce the profile of the imaging lens. It should be noted that a low profile herein refers to a small ratio (total track length/diagonal length=total track/diagonal ratio) of the total track length, that is, the distance along the optical axis between the object-side surface of the first lens and the image plane to the diagonal length of the image plane of the image sensor.

It is preferable that, in the imaging lens in the above configuration, the eighth lens has an aspheric image-side surface having at least one inflection point. The eighth lens with the image-side surface formed in an aspheric shape having an inflection point allows satisfactory correction of field curvature and distortion at an image periphery while securing a back focus. The shape of the eighth lens also allows satisfactory correction of the aberrations in the paraxial and peripheral regions while controlling an incident angle of a ray of light emitted from the imaging lens on the image plane of the image sensor to be within the range of chief ray angle (CRA).

It is preferable that, in the imaging lens in the above configuration, the eighth lens has an image-side surface being concave in the paraxial region. The eighth lens formed in such a meniscus shape having the object-side surface being convex in the paraxial region allows more preferable achievement of reduction in the profile of the imaging lens.

It should be noted that a “lens” in the present invention refers to an optical element having refractive power. Accordingly, the term “lens” used herein does not include optical elements such as a prism to change a direction of light travel and a flat filter. These optical elements may be arranged in front of or behind the imaging lens or between respective lenses, as necessary.

It is preferable that the imaging lens in the above configuration satisfies a conditional expression (1) below:

−3.0<f2/f3<−0.2 (1)

where

f2: a focal length of the second lens, and

f3: a focal length of the third lens.

Satisfaction of the conditional expression (1) allows balanced and satisfactory correction of astigmatism, field curvature, and spherical aberration in preferred ranges while reducing the profile of the imaging lens.

It is preferable that the imaging lens in the above configuration satisfies a conditional expression (2) below:

1.0<f3/f<8.0 (2)

where

f: a focal length of entire optical system of the imaging lens, and

f3: a focal length of the third lens.

Satisfaction of the conditional expression (2) allows satisfactory correction of the astigmatism and the field curvature while reducing the profile of the imaging lens.

It is preferable that the imaging lens in the above configuration satisfies a conditional expression (3) below:

1.0<f4/f3<35.0 (3)

where

f3: a focal length of the third lens, and

f4: a focal length of the fourth lens.

Satisfaction of the conditional expression (3) allows satisfactory correction of the astigmatism and the field curvature while reducing the profile of the imaging lens.

It is preferable that the imaging lens in the above configuration satisfies a conditional expression (4) below:

1.0<f34/f<6.0 (4)

where

f: a focal length of entire optical system of the imaging lens, and

f34: a composite focal length of the third lens and the fourth lens.

Satisfaction of the conditional expression (4) allows satisfactory correction of the astigmatism and the field curvature while reducing the profile of the imaging lens.

It is preferable that the imaging lens in the above configuration satisfies a conditional expression (5) below:

0.5<|f4/f5|<15.0 (5)

where

f4: a focal length of the fourth lens, and

f5: a focal length of the fifth lens.

Satisfaction of the conditional expression (5) allows balanced and satisfactory correction of the field curvature, the astigmatism, and coma aberration while reducing the profile of the imaging lens.

It is preferable that the imaging lens in the above configuration satisfies a conditional expression (6) below:

0.5<f7/f8<15.0 (6)

where

f7: a focal length of the seventh lens, and

f8: a focal length of the eighth lens.

Satisfaction of the conditional expression (6) allows satisfactory correction of the field curvature and the astigmatism while reducing the profile of the imaging lens.

It is preferable that the imaging lens in the above configuration satisfies a conditional expression (7) below:

−15.0<f8/f1<−0.8 (7)

where

f1: a focal length of the first lens, and

f8: a focal length of the eighth lens.

Satisfaction of the conditional expression (7) allows balanced and satisfactory correction of the astigmatism, the field curvature, and the spherical aberration in preferred ranges while reducing the profile of the imaging lens.

It is preferable that the imaging lens in the above configuration satisfies a conditional expression (8) below:

−15.0<f8/f<−0.8 (8)

where

f: a focal length of entire optical system of the imaging lens, and

f8: a focal length of the eighth lens.

Satisfaction of the conditional expression (8) allows satisfactory correction of the field curvature, the astigmatism, and distortion while reducing the profile of the imaging lens.

In addition, the spherical aberration and the coma aberration are satisfactorily corrected.

It is preferable that the imaging lens in the above configuration satisfies a conditional expression (9) below:

−7.0<R3r/R5f<−0.4 (9)

where

R3r: a paraxial curvature radius of an image-side surface of the third lens, and

R5f: a paraxial curvature radius of an object-side surface of the fifth lens.

Satisfaction of the conditional expression (9) allows satisfactory correction of the field curvature and the astigmatism while reducing the profile of the imaging lens.

It is preferable that the imaging lens in the above configuration satisfies a conditional expression (10) below:

0.4<D45/D34<4.0 (10)

where

D45: a distance along the optical axis between the fourth lens and the fifth lens, and

D34: a distance along the optical axis between the third lens and the fourth lens.

Satisfaction of the conditional expression (10) allows satisfactory correction of the field curvature and the astigmatism while reducing the profile of the imaging lens.

It is preferable that the imaging lens in the above configuration satisfies a conditional expression (11) below:

0.3<D34/T3<1.3 (11)

where

D34: a distance along the optical axis between the third lens and the fourth lens, and

T3: a thickness along the optical axis of the third lens.

Satisfaction of the conditional expression (11) allows satisfactory correction of the field curvature and the astigmatism while reducing the profile of the imaging lens.

It is preferable that the imaging lens in the above configuration satisfies a conditional expression (12) below:

35<vd3<85 (12)

where

vd3: an abbe number at d-ray of the third lens. Satisfaction of the conditional expression (12) allows satisfactory correction of chromatic aberration.

It is preferable that the imaging lens in the above configuration satisfies a conditional expression (13) below to more satisfactorily correct chromatic aberration:

35<vd6<85 (13)

where

vd6: an abbe number at d-ray of the sixth lens.

It is preferable that the imaging lens in the above configuration satisfies a conditional expression (14) below to more satisfactorily correct chromatic aberration:

35<vd8<85 (14)

where

vd8: an abbe number at d-ray of the eighth lens.

It is preferable that the imaging lens in the above configuration satisfies a conditional expression (15) below:

0≤|vd7−vd8|/vd8<0.50 (15)

where

vd7: an abbe number at the d-ray of the seventh lens, and

vd8: an abbe number at the d-ray of the eighth lens.

The seventh lens and the eighth lens are arranged in positions close to the image plane of the image sensor among the eight lenses. The seventh lens and the eighth lens have negative refractive power. As represented by the conditional expressions (14) and (15), chromatic aberration may be even more satisfactorily corrected when the two lenses are formed from a low dispersion material.

It is preferable that the imaging lens of the present invention satisfies a total track/diagonal ratio represented by the conditional expression below to preferably achieve reduction in the profile of the imaging lens:

0.5<TTL/(2×ih)<1.0

where

TTL: a distance along the optical axis between the object-side surface of the first lens and the image plane, and

ih: a maximum image height on the image plane of the image sensor.

It should be noted that inserts, such as a IR cut filter and a cover glass, are generally arranged between the imaging lens and the image plane while a thickness of a IR cut filter or a cover glass along the optical axis is converted into an air-converted distance herein.

It is preferable that, in the imaging lens of the present invention, each of the first to the eighth lenses is arranged with an air gap. Arrangement of each lens with an air gap allows the imaging lens of the present invention to have a lens configuration where not even one cemented lens is contained. Such a lens configuration allows all the eight lenses composing the imaging lens to be formed from plastic materials and thus reduction in the production cost of the imaging lens.

It is preferable that, in the imaging lens of the present invention, both surfaces of each of the first to the eighth lenses are formed as aspheric surfaces. Formation of both surfaces of each lens as aspheric surfaces allows more satisfactory correction of aberrations from the paraxial region to the lens periphery. Particularly, the imaging lens of the present invention is high in capacity of the aberration correction at the peripheral area of the lens due to aspheric surfaces.

It is preferable that, when a field of view is given as 2ω, the imaging lens of the present invention satisfies 70°≤2ω. Satisfaction of the present conditional expression allows the imaging lens to have a wider field of view and it is thus possible to achieve a wider field of view as well as a lower profile of the imaging lens.

The surface shapes of each lens herein are specified using signs of the radii of curvature. Whether the curvature radius is positive or negative is determined in accordance with a general definition, that is, given that the traveling direction of the light is positive, the curvature radius is considered to be positive if the center of the curvature radius is on the image plane side viewed from the lens surface and the curvature radius is considered to be negative if the center is on the object side. Accordingly, an “object-side surface with a positive curvature radius” refers to a convex object-side surface, and an “object-side surface with a negative curvature radius” refers to a concave object-side surface. In addition, an “image-side surface with a positive curvature radius” refers to a concave image-side surface, and an “image-side surface with a negative curvature radius” refers to a convex image-side surface. It should be noted that the curvature radius herein refers to a paraxial curvature radius and may not be consistent with outlines of the lenses in their sectional views.

The imaging lens of the present invention is capable of providing a compact imaging lens particularly suitable for assembly into a small-sized camera while achieving high resolution with satisfactorily corrected aberrations.

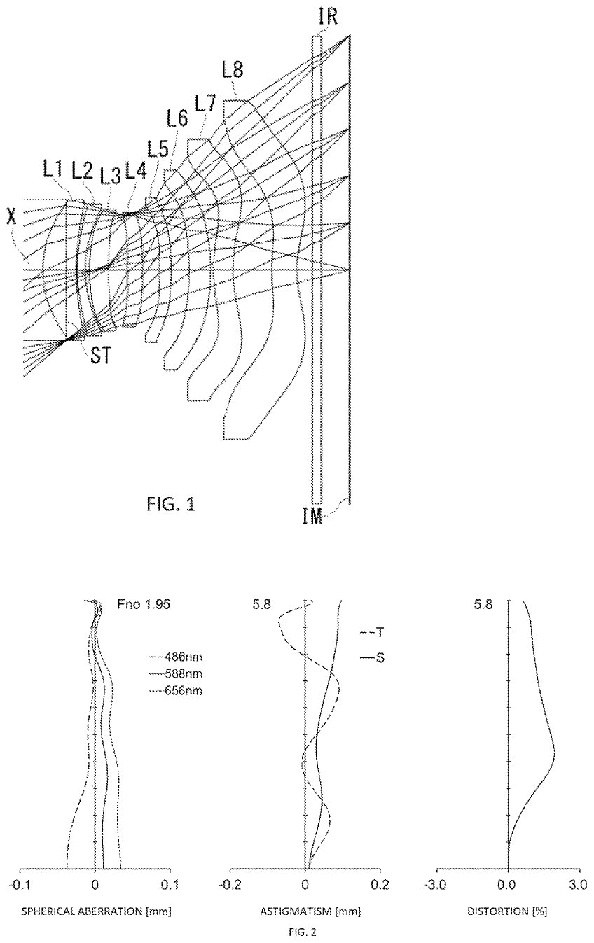

FIG. 1 is a sectional view illustrating a schematic configuration of an imaging lens according to Example 1 of the present invention;

FIG. 2 is an aberration diagram illustrating spherical aberration, astigmatism, and distortion of the imaging lens in FIG. 1;

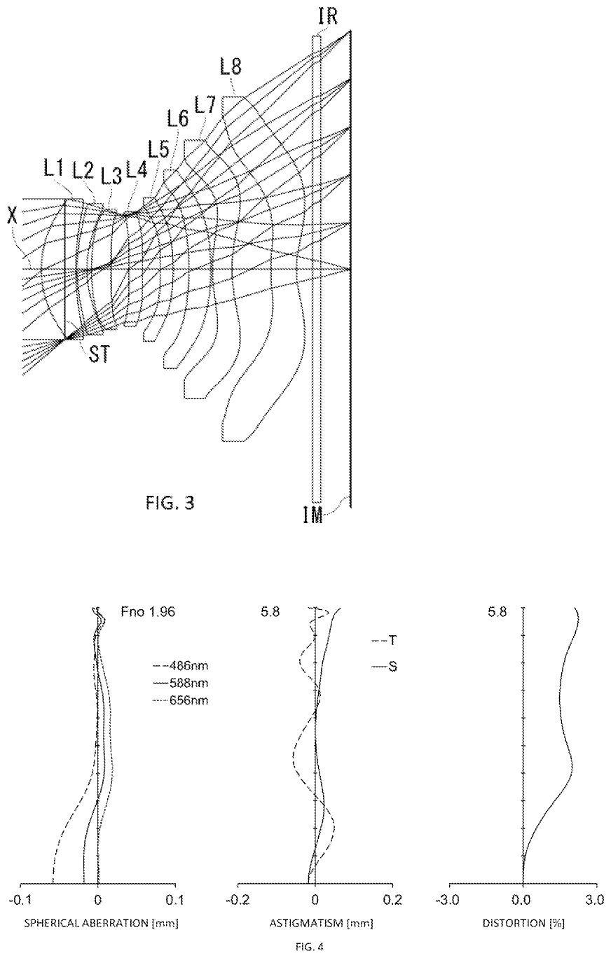

FIG. 3 is a sectional view illustrating a schematic configuration of an imaging lens according to Example 2 of the present invention;

FIG. 4 is an aberration diagram illustrating spherical aberration, astigmatism, and distortion of the imaging lens in FIG. 3;

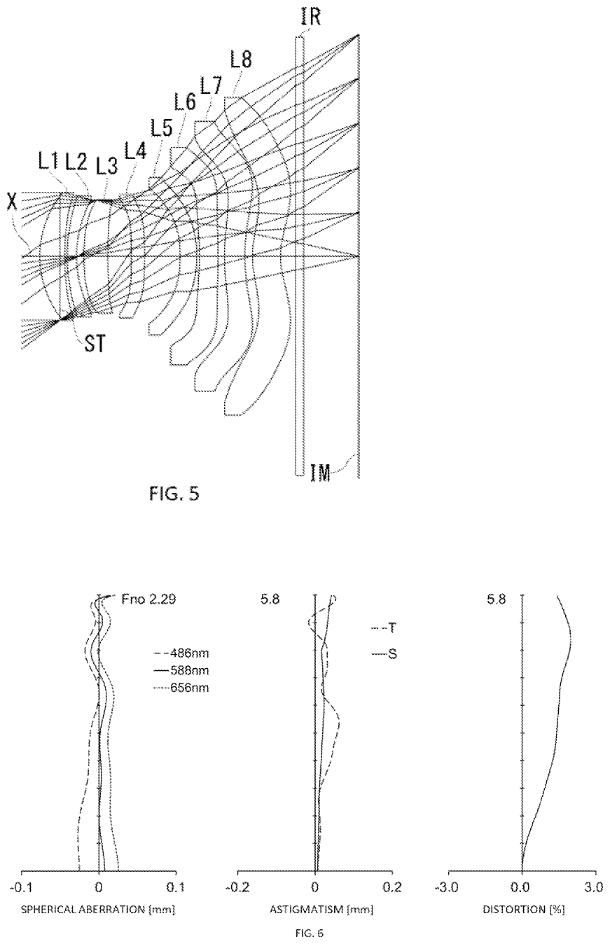

FIG. 5 is a sectional view illustrating a schematic configuration of an imaging lens according to Example 3 of the present invention;

FIG. 6 is an aberration diagram illustrating spherical aberration, astigmatism, and distortion of the imaging lens in FIG. 5;

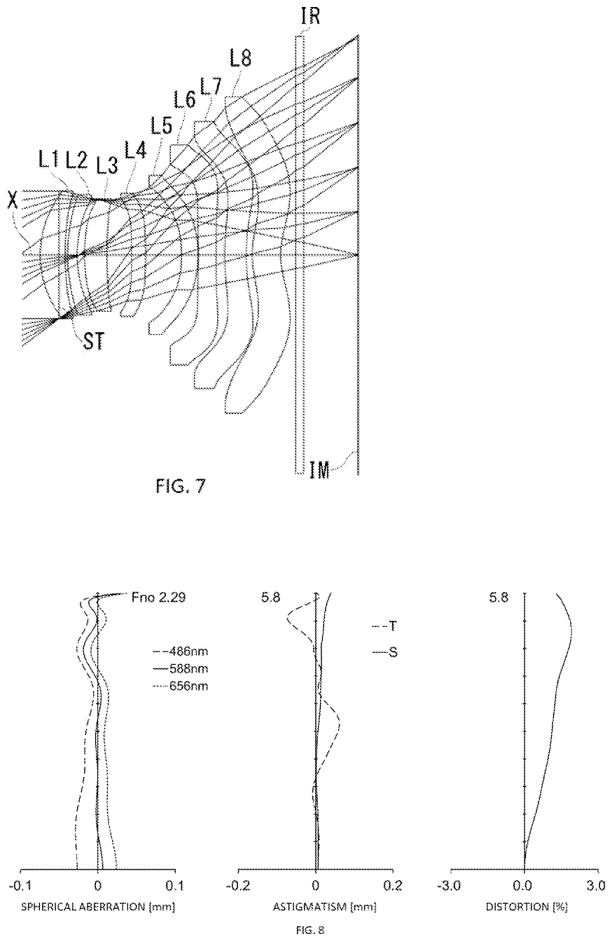

FIG. 7 is a sectional view illustrating a schematic configuration of an imaging lens according to Example 4 of the present invention;

FIG. 8 is an aberration diagram illustrating spherical aberration, astigmatism, and distortion of the imaging lens in FIG. 7;

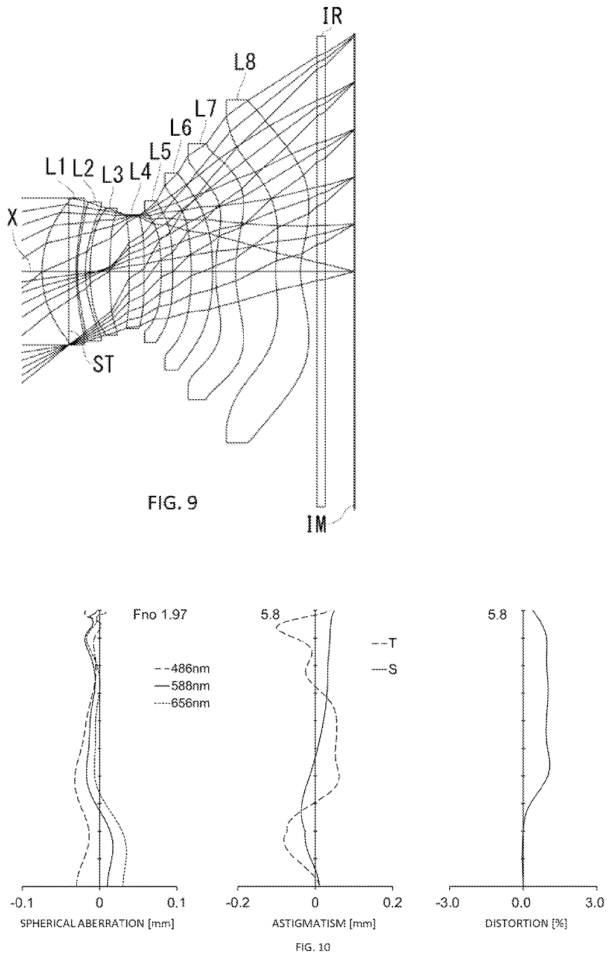

FIG. 9 is a sectional view illustrating a schematic configuration of an imaging lens according to Example 5 of the present invention;

FIG. 10 is an aberration diagram illustrating spherical aberration, astigmatism, and distortion of the imaging lens in FIG. 9;

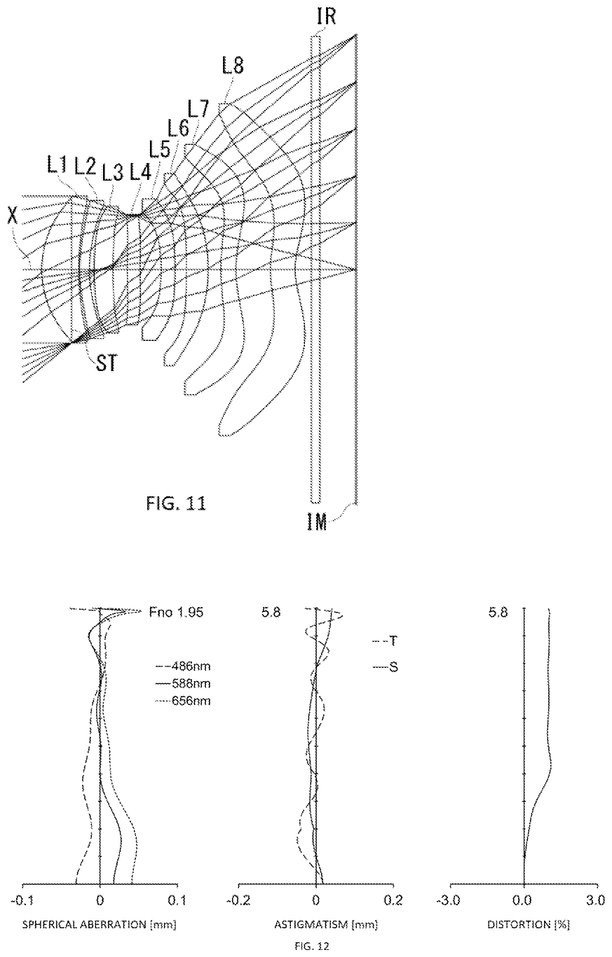

FIG. 11 is a sectional view illustrating a schematic configuration of an imaging lens according to Example 6 of the present invention;

FIG. 12 is an aberration diagram illustrating spherical aberration, astigmatism, and distortion of the imaging lens in FIG. 11;

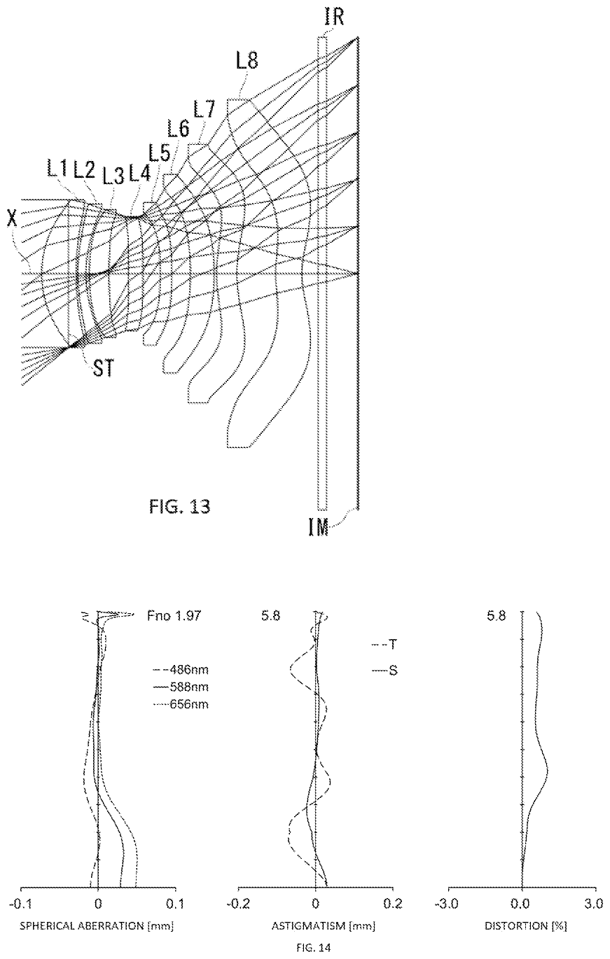

FIG. 13 is a sectional view illustrating a schematic configuration of an imaging lens according to Example 7 of the present invention;

FIG. 14 is an aberration diagram illustrating spherical aberration, astigmatism, and distortion of the imaging lens in FIG. 13;

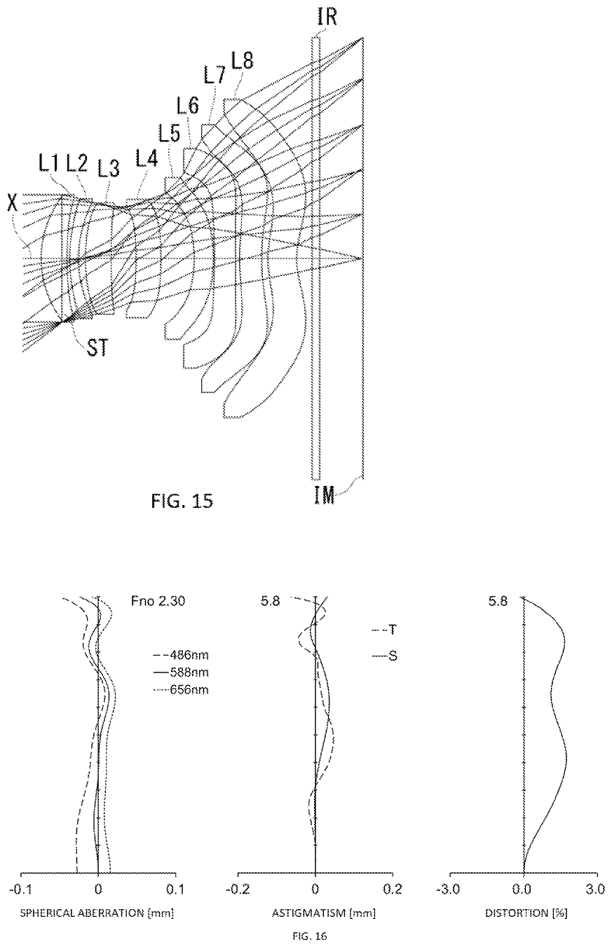

FIG. 15 is a sectional view illustrating a schematic configuration of an imaging lens according to Example 8 of the present invention; and

FIG. 16 is an aberration diagram illustrating spherical aberration, astigmatism, and distortion of the imaging lens in FIG. 15.

### DETAILED DESCRIPTION OF EMBODIMENTS

Referring to the accompanying drawings, an embodiment of the present invention will be described in detail below.

FIGS. 1, 3, 5, 7, 9, 11, 13, and 15 are sectional views illustrating schematic configurations of respective imaging lenses according to Examples 1 through 8 of the present embodiments. Since the imaging lenses in these Examples have the same basic configuration, a description is given here to the lens configuration according to the present embodiment with reference to the illustrative sectional view of Example 1.

As illustrated in FIG. 1, the imaging lens according to the present embodiment includes: in order from an object side to an image side, a first lens L1 having positive refractive power; a second lens L2 having negative refractive power; a third lens L3 having positive refractive power; a fourth lens L4 having positive refractive power; a fifth lens L5; a sixth lens L6; a seventh lens L7 having negative refractive power; and an eighth lens L8 having negative refractive power. Each lens of the first lens L1 to the eighth lens L8 is arranged with an air gap. A filter IR is arranged between the eighth lens L8 and an image plane IM of the image sensor. The filter IR is optional. It should be noted that, unless otherwise specified, refractive power of each lens herein refers to refractive power in a paraxial region.

The first lens L1 has a shape where a curvature radius r2 of an object-side surface and a curvature radius r3 of an image-side surface are both positive. The first lens L1 has a shape of a meniscus lens with an object-side surfaced being convex in a paraxial region. The shape of the first lens L1 is not limited to the shape according to Example 1. The first lens L1 may have a shape to provide positive refractive power. For example, the first lens L1 may have a shape where the curvature radius r2 is positive and the curvature radius r3 is negative, that is, a shape providing a biconvex lens in the paraxial region. The first lens L1 may have a shape where the curvature radius r2 of the object-side surface and the curvature radius r3 of the image-side surface are both negative, and also a shape providing a meniscus lens with the object-side surface being concave in the paraxial region. From the perspective of reduction in the profile of the imaging lens, a shape where the curvature radius r2 is positive is preferable.

The second lens L2 has a shape where a curvature radius r4 of an object-side surface and a curvature radius r5 of an image-side surface are both positive. The second lens L2 has a shape providing a meniscus lens with the object-side surface being convex in a paraxial region. The shape of the second lens L2 is not limited to the shape according to Example 1 and may be a shape to provide negative refractive power. For example, the second lens L2 may have a shape where the curvature radius r4 is negative and the curvature radius r5 is positive and also a shape providing a biconcave lens in the paraxial region, or may have a shape providing a meniscus lens with the object-side surface being concave in the paraxial region. From the perspective of reduction in the profile of the imaging lens, it is preferable that the second lens L2 has a shape where the curvature radius r4 is positive.

The third lens L3 has a shape where a curvature radius r6 of an object-side surface and a curvature radius r7 (=R3r) of an image-side surface are both positive. The third lens L3 has a shape providing a meniscus lens with the object-side surface being convex in a paraxial region. The shape of the third lens L3 is not limited to the shape according to Example 1. The third lens L3 may have a shape to provide positive refractive power. For example, the third lens L3 may have a shape providing a biconvex lens in the paraxial region, or may have a shape providing a meniscus lens with the object-side surface being concave in the paraxial region. From the perspective of reduction in the profile of the imaging lens, it is preferable that the third lens L3 has a shape where the curvature radius r6 is positive.

The fourth lens L4 has a shape where a curvature radius r8 of an object-side surface is positive and a curvature radius r9 of an image-side surface is negative. The fourth lens L4 has a shape providing a biconvex lens in a paraxial region. The shape of the fourth lens L4 is not limited to the shape according to Example 1. The fourth lens L4 may have a shape to provide positive refractive power. The fourth lens L4 in each of Examples 2 and 6 is an example of a shape providing a meniscus lens with the object-side surface being convex in the paraxial region. Meanwhile, the fourth lens L4 in each of Examples 3, 4 and 8 is an example of a shape providing a meniscus lens with the object-side surface being concave in the paraxial region.

The fifth lens L5 has positive refractive power. The refractive power of the fifth lens L5 is not limited to the positive refractive power. The imaging lens according to each of Examples 5 through 8 is an example of a lens configuration where the fifth lens L5 has negative refractive power.

The fifth lens L5 has a shape where a curvature radius r10 (=R5f) of an object-side surface and a curvature radius r11 of an image-side surface are both negative. The fifth lens L5 has a shape providing a meniscus lens with the object-side surface being concave in a paraxial region. The shape of the fifth lens L5 is not limited to the shape according to Example 1. The fifth lens L5 may have a shape providing a biconcave lens in the paraxial region, a shape providing a biconvex lens in the paraxial region, or a shape providing a meniscus lens with the convex object-side surface.

The sixth lens L6 has positive refractive power. The refractive power of the sixth lens L6 is not limited to the positive refractive power. The imaging lens according to each of Examples 3, 4 and 8 is an example of a lens configuration where the sixth lens L6 has negative refractive power.

The sixth lens L6 has a shape where a curvature radius r12 of an object-side surface and a curvature radius r13 of an image-side surface are both negative. The sixth lens L6 has a shape providing a meniscus lens with the object-side surface being concave in a paraxial region. The shape of the sixth lens L6 is not limited to the shape according to Example 1 and may be a shape providing a concave object-side surface in the paraxial region. The sixth lens L6 in Example 4 is an example of a shape providing a biconcave lens in the paraxial region.

The seventh lens L7 has a shape where a curvature radius r14 of an object-side surface and a curvature radius r15 of an image-side surface are both positive. The seventh lens L7 has a shape providing a meniscus lens with the convex object-side surface in a paraxial region. The shape of the seventh lens L7 is not limited to the shape according to Example 1. The seventh lens L7 may have a shape to provide negative refractive power. The seventh lens L7 may have a shape providing a biconcave lens in the paraxial region or a shape providing a meniscus lens with the concave object-side surface in the paraxial region.

The eighth lens L8 has a shape where a curvature radius r16 of an object-side surface and a curvature radius r17 of an image-side surface are both positive. The eighth lens L8 has a shape providing a meniscus lens with a convex object-side surface in a paraxial region.

Both surfaces of the seventh lens L7 and the eighth lens L8 are aspheric and provided with an inflection point. In this context, the inflection point refers to a point where the positive or negative sign of the curvature on a curve, which is a point where the curving direction of the curve changes on the lens surface. Both surfaces of the seventh lens L7 and the eighth lens L8 in the imaging lens according to the present embodiment respectively have an aspheric shape with a pole point. Such a shape of the seventh lens L7 and the eighth lens L8 allows satisfactory correction of not only axial chromatic aberration but also off-axial chromatic aberration of magnification as well as preferable control of the incident angle of a ray of light emitted from the imaging lens on the image plane IM within the range of CRA. It should be noted that, depending on the expected optical performance and the extent of reduction in the profile of the imaging lens, the eighth lens L8 may have the other surfaces except for the image-side surface formed as aspheric surfaces with no inflection point.

The imaging lens according to the present embodiment satisfies the following conditional expressions (1) through (15):

−3.0<f2/f3<−0.2 (1)

1.0<f3/f<8.0 (2)

1.0<f4/f3<35.0 (3)

1.0<f34/f<6.0 (4)

0.5<|f4/f5|<15.0 (5)

0.5<f7/f8<15.0 (6)

−15.0<f8/f1<−0.8 (7)

−15.0<f8/f<−0.8 (8)

−7.0<R3r/R5f<−0.4 (9)

0.4<D45/D34<4.0 (10)

0.3<D34/T3<1.3 (11)

35<vd3<85 (12)

35<vd6<85 (13)

35<vd8<85 (14)

0≤|vd7−vd8|/vd8<0.50 (15)

where

f: a focal length of entire optical system of the imaging lens,

f1: a focal length of the first lens L1,

f2: a focal length of the second lens L2,

f3: a focal length of the third lens L3,

f4: a focal length of the fourth lens L4,

f5: a focal length of the fifth lens L5,

f7: a focal length of the seventh lens L7,

f8: a focal length of the eighth lens L8,

f34: a composite focal length of the third lens L3 and the fourth lens L4,

R3r: a paraxial curvature radius of an image-side surface of the third lens L3,

R5f: a paraxial curvature radius of an object-side surface of the fifth lens L5.

D34: a distance along the optical axis X between the third lens L3 and the fourth lens L4,

D45: a distance along the optical axis X between the fourth lens L4 and the fifth lens L5,

T3: a thickness along the optical axis X of the third lens L3,

vd3: an abbe number at d-ray of the third lens L3.

vd6: an abbe number at d-ray of the sixth lens L6.

vd7: an abbe number at the d-ray of the seventh lens L7, and

vd8: an abbe number at d-ray of the eighth lens L8.

The imaging lens according to the present embodiment satisfies the total track/diagonal ratio represented by the following conditional expression:

0.5<TTL/(2×ih)<1.0

where

TTL: a distance along the optical axis X between the object-side surface of the first lens L1 and the image plane IM, and

ih: a maximum image height on the image plane IM of the image sensor.

In addition, the imaging lens according to the present embodiment satisfies the following conditional expression:

70°≤2ω

where

ω: a half field of view.

It should be noted that not all the above conditional expressions have to be satisfied and each of the above conditional expressions may be individually satisfied to obtain the operational advantage corresponding to each conditional expression.

The imaging lens according to the present embodiment exhibits more preferred operational advantage by satisfying conditional expressions (1a), (2a) and (4a) through (11a) below:

−2.0<f2/f3<−0.5 (1a)

1.5<f3/f<7.0 (2a)

1.3<f34/f<5.0 (4a)

0.7<|f4/f5|<12.0 (5a)

0.7<f7/f8<12.0 (6a)

−14.0<f8/f1<−1.0 (7a)

−14.0<f8/f<−1.0 (8a)

−6.0<R3r/R5f<−0.5 (9a)

0.6<D45/D34<3.5 (10a)

0.5<D34/T3<1.2 (11a).

The imaging lens according to the Examples 1 to 7 satisfies conditional expressions (3a) and (3b) below:

1.0<f4/f3<15.0 (3a)

1.0<f4/f3<12.0 (3b).

It should be noted that, as the upper limits and the lower limits of these conditional expressions (1a) through (11a), the upper limits and the lower limits of the corresponding conditional expressions (1) through (11) may be applied to the respective conditional expressions (1a) through (11a).

According to the present embodiment, lens surfaces of the respective lenses are formed as aspheric surfaces. An equation that expresses these aspheric surfaces is as below:

$$Z = \frac{C \cdot {H}^{2}}{1 + \sqrt{1 - ( 1 + k ) \cdot {C}^{2} \cdot {H}^{2}}} + \sum ( An \cdot {H}^{n} ) \qquad [ Equation 1 ]$$

where

Z: a distance in the direction of the optical axis,

H: a distance from the optical axis in the direction perpendicular to the optical axis,

C: a paraxial curvature (=1/r, r: paraxial curvature radius),

k: conic constant, and

An: the nth aspheric coefficient.

Next, Examples of the imaging lens according to the present embodiment will be described.

In each table showing basic lens data, f represents a focal length of the entire optical system of the imaging lens, Fno represents an F-number, w represents a half field of view, ih represents a maximum image height on the image plane IM, and TTL represents a distance along the optical axis between the object-side surface of the first lens L1 and the image plane IM. Additionally, i represents a surface number counted from the object side, r represents a paraxial curvature radius, d represents a distance between lens surfaces along the optical axis X, nd represents a refractive index at a reference wavelength of 588 nm, and vd represents an abbe number at the reference wavelength. It should be noted that surfaces indicated by surface numbers i affixed with an asterisk (*) are aspheric surfaces.

### Example 1

The basic lens data is shown below.

TABLE 1
Example 1
Unit mm

f = 6.820
Fno = 1.95
ω(°) = 40.4
h = 5.8
TTL = 7.54

Surface Data

| i | r | d | nd | νd | |
|---|---|---|---|---|---|
| (Object) | Infinity | Infinity | | | |
| 1 (Stop) | Infinity | −0.583 | | | |
| 2* | 2.542 | 0.835 | 1.544 | 56.44 | (νd1) |
| 3* | 5.480 | 0.019 | | | |
| 4* | 3.547 | 0.199 | 1.671 | 19.24 | (νd2) |
| 5* | 2.754 | 0.109 | | | |
| 6* | 5.049 | 0.472 | 1.544 | 56.44 | (νd3) |
| 7* | 10.157 | 0.472 | | | |
| 8* | 103.781 | 0.365 | 1.567 | 37.40 | (νd4) |
| 9* | −124.744 | 0.430 | | | |
| 10* | −16.378 | 0.278 | 1.671 | 19.24 | (νd5) |
| 11* | −11.239 | 0.451 | | | |
| 12* | −7.920 | 0.532 | 1.535 | 55.69 | (νd6) |
| 13* | −6.560 | 0.078 | | | |
| 14* | 3.854 | 0.483 | 1.535 | 55.69 | (νd7) |
| 15* | 3.400 | 0.956 | | | |
| 16* | 3.888 | 0.618 | 1.535 | 55.69 | (νd8) |
| 17* | 2.020 | 0.400 | | | |
| 18 | Infinity | 0.210 | 1.517 | 64.20 | |
| 19 | Infinity | 0.703 | | | |
| Image Plane | | | | | |

Constituent Lens Data

| Lens | Start Surface | Focal Length | Total Track/Diagonal Ratio |
|---|---|---|---|
| L1 | 2 | 7.913 | 0.65 |
| L2 | 4 | −20.428 | |
| L3 | 6 | 17.861 | |
| L4 | 8 | 99.939 | |
| L5 | 10 | 52.274 | |
| L6 | 12 | 62.840 | |
| L7 | 14 | −85.981 | |
| L8 | 16 | −8.886 | |

TABLE 2
Aspheric Surface Data

| | 2nd Surface | 3rd Surface | 4th Surface | 5th Surface | 6th Surface | 7th Surface |
|---|---|---|---|---|---|---|
| k | −8.277999E−01 | 0.000000E+00 | −2.671493E+00 | −1.783998E+00 | 0.000000E+00 | 0.000000E+00 |
| A4 | 9.060554E−03 | −5.307070E−02 | −5.356112E−02 | 1.063473E−02 | 1.811011E−02 | −2.129659E−02 |
| A6 | −1.699218E−02 | 7.902392E−02 | 7.522910E−02 | −6.306038E−02 | −5.048025E−02 | 7.548814E−02 |
| A8 | 3.529254E−02 | −6.834553E−02 | −7.155800E−02 | 2.002251E−01 | 1.536799E−01 | −2.002484E−01 |
| A10 | −4.209787E−02 | 1.938183E−02 | 1.480992E−02 | −3.731079E−01 | −2.546573E−01 | 3.481915E−01 |
| A12 | 3.084592E−02 | 2.328218E−02 | 4.280527E−02 | 4.012219E−01 | 2.422895E−01 | −3.771925E−01 |
| A14 | −1.411541E−02 | −2.733254E−02 | −4.740877E−02 | −2.558146E−01 | −1.323420E−01 | 2.625033E−01 |
| A16 | 3.925520E−03 | 1.244137E−02 | 2.216028E−02 | 9.642752E−02 | 4.142942E−02 | −1.133542E−01 |
| A18 | −6.064244E−04 | −2.747052E−03 | −5.056545E−03 | −1.998595E−02 | −6.902013E−03 | 2.786824E−02 |
| A20 | 3.968963E−05 | 2.427095E−04 | 4.609521E−04 | 1.766124E−03 | 4.674960E−04 | −3.017851E−03 |
| | 8th Surface | 9th Surface | 10th Surface | 11th Surface | 12th Surface | 13th Surface |
| k | 0.000000E+00 | 0.000000E+00 | 0.000000E+00 | 0.000000E+00 | 0.000000E+00 | 0.000000E+00 |
| A4 | −4.379986E−02 | 4.135533E−02 | −8.143056E−02 | −7.031471E−02 | −5.054079E−02 | −4.941235E−02 |
| A6 | 6.059681E−03 | −3.740304E−02 | 1.611628E−01 | 1.142274E−01 | 8.320604E−02 | 5.737468E−02 |
| A8 | −3.915011E−02 | 9.305937E−02 | −3.533291E−01 | −1.792210E−01 | −8.229731E−02 | −3.866334E−02 |
| A10 | 8.409570E−02 | −1.573678E−01 | 4.551749E−01 | 1.708183E−01 | 5.284967E−02 | 1.601017E−02 |
| A12 | −1.007089E−01 | 1.673576E−01 | −3.827299E−01 | −1.085981E−01 | −2.487684E−02 | −4.702255E−03 |
| A14 | 8.038893E−02 | −1.061707E−01 | 2.142384E−01 | 4.812144E−02 | 8.327545E−03 | 9.731687E−04 |
| A16 | −4.062783E−02 | 3.953110E−02 | −7.569105E−02 | −1.409167E−02 | −1.803110E−03 | −1.273989E−04 |
| A18 | 1.158819E−02 | −8.024934E−03 | 1.502453E−02 | 2.382458E−03 | 2.197925E−04 | 9.028992E−06 |
| A20 | −1.430170E−03 | 6.820654E−04 | −1.264323E−03 | −1.721987E−04 | −1.126540E−05 | −2.544471E−07 |

| | 14th Surface | 15th Surface | 16th Surface | 17th Surface |
|---|---|---|---|---|
| k | −9.054088E−01 | 2.601259E−02 | −9.547094E−01 | −7.442675E+00 |
| A4 | −4.465804E−02 | −3.632486E−02 | −1.270692E−01 | −5.360264E−02 |
| A6 | 1.572657E−02 | 9.640974E−03 | 4.895421E−02 | 1.780061E−02 |
| A8 | −9.689651E−03 | −5.950799E−03 | −1.369150E−02 | −4.159658E−03 |
| A10 | 3.100840E−03 | 2.119258E−03 | 2.395148E−03 | 5.959207E−04 |
| A12 | −5.736122E−04 | −4.723369E−04 | −2.568714E−04 | −5.403355E−05 |
| A14 | 5.319589E−05 | 6.758335E−05 | 1.695429E−05 | 3.172981E−06 |
| A16 | −2.373605E−07 | −6.051769E−06 | −6.683707E−07 | −1.181778E−07 |
| A18 | −3.292743E−07 | 3.086265E−07 | 1.423040E−08 | 2.559822E−09 |
| A20 | 1.692268E−08 | −6.813790E−09 | −1.222780E−10 | −2.484123E−11 |

FIG. 2 is an aberration diagram illustrating spherical aberration (mm), astigmatism (mm), and distortion (%) of the imaging lens in Example 1, respectively. The astigmatism diagram and distortion diagram represent the aberrations at the reference wavelength (588 nm). Furthermore, the astigmatism diagram represents a sagittal image surface (S) and a tangential image surface (T), respectively (same in FIGS. 4, 6, 8, 10, 12, 14, and 16). As shown in FIG. 2, the imaging lens according to Example 1 is capable of satisfactorily correcting the aberrations.

### Example 2

The basic lens data is shown below.

TABLE 3
Example 2
Unit mm

f = 6.860
Fno = 1.96
ω(°) = 40.2
h = 5.8
TTL = 7.62

Surface Data

| i | r | d | nd | νd | |
|---|---|---|---|---|---|
| (Object) | Infinity | Infinity | | | |
| 1 (Stop) | Infinity | −0.583 | | | |
| 2* | 2.526 | 0.860 | 1.544 | 56.44 | (νd1) |
| 3* | 5.591 | 0.028 | | | |
| 4* | 3.603 | 0.248 | 1.671 | 19.24 | (νd2) |
| 5* | 2.716 | 0.110 | | | |
| 6* | 5.313 | 0.487 | 1.544 | 56.44 | (νd3) |
| 7* | 14.031 | 0.446 | | | |
| 8* | 49.322 | 0.337 | 1.567 | 37.40 | (νd4) |
| 9* | 117.071 | 0.454 | | | |
| 10* | −7.071 | 0.305 | 1.671 | 19.24 | (νd5) |
| 11* | −6.722 | 0.392 | | | |
| 12* | −7.764 | 0.549 | 1.535 | 55.69 | (νd6) |
| 13* | −6.047 | 0.041 | | | |
| 14* | 3.857 | 0.482 | 1.535 | 55.69 | (νd7) |
| 15* | 3.410 | 0.965 | | | |
| 16* | 3.814 | 0.633 | 1.535 | 55.69 | (νd8) |
| 17* | 2.038 | 0.400 | | | |
| 18 | Infinity | 0.210 | 1.517 | 64.20 | |
| 19 | Infinity | 0.747 | | | |
| Image Plane | | | | | |

Constituent Lens Data

| Lens | Start Surface | Focal Length | Total Track/Diagonal Ratio |
|---|---|---|---|
| L1 | 2 | 7.700 | 0.66 |
| L2 | 4 | −18.540 | |
| L3 | 6 | 15.404 | |
| L4 | 8 | 150.001 | |
| L5 | 10 | 149.979 | |
| L6 | 12 | 45.996 | |
| L7 | 14 | −88.122 | |
| L8 | 16 | −9.344 | |

TABLE 4
Aspheric Surface Data

| | 2nd Surface | 3rd Surface | 4th Surface | 5th Surface | 6th Surface | 7th Surface |
|---|---|---|---|---|---|---|
| k | −8.323513E−01 | 0.000000E+00 | −2.713231E+00 | −1.779705E+00 | 0.000000E+00 | 0.000000E+00 |
| A4 | 8.959020E−03 | −5.292873E−02 | −5.354749E−02 | 1.051732E−02 | 1.801068E−02 | −2.104013E−02 |
| A6 | −1.685330E−02 | 7.897293E−02 | 7.534770E−02 | −6.323151E−02 | −5.025840E−02 | 7.532188E−02 |
| A8 | 3.531062E−02 | −6.833622E−02 | −7.154064E−02 | 2.002295E−01 | 1.536782E−01 | −2.001603E−01 |
| A10 | −4.210075E−02 | 1.938578E−02 | 1.480972E−02 | −3.731057E−01 | −2.546733E−01 | 3.482220E−01 |
| A12 | 3.084366E−02 | 2.328265E−02 | 4.280426E−02 | 4.012220E−01 | 2.422895E−01 | −3.772056E−01 |
| A14 | −1.411610E−02 | −2.733255E−02 | −4.740927E−02 | −2.558166E−01 | −1.323433E−01 | 2.624881E−01 |
| A16 | 3.925450E−03 | 1.244128E−02 | 2.215985E−02 | 9.642632E−02 | 4.142834E−02 | −1.133629E−01 |
| A18 | −6.064244E−04 | −2.747052E−03 | −5.056545E−03 | −1.998595E−02 | −6.902013E−03 | 2.786824E−02 |
| A20 | 3.970709E−05 | 2.426800E−04 | 4.608191E−04 | 1.765397E−03 | 4.676981E−04 | −3.020834E−03 |
| | 8th Surface | 9th Surface | 10th Surface | 11th Surface | 12th Surface | 13th Surface |
| k | 0.000000E+00 | 0.000000E+00 | 0.000000E+00 | 0.000000E+00 | 0.000000E+00 | 0.000000E+00 |
| A4 | −4.451838E−02 | −4.004645E−02 | −8.122725E−02 | −7.069076E−02 | −5.102355E−02 | −4.924608E−02 |
| A6 | 6.002161E−03 | −3.724906E−02 | 1.610393E−01 | 1.143858E−01 | 8.327285E−02 | 5.737439E−02 |
| A8 | −3.900833E−02 | 9.304246E−02 | −3.532836E−01 | −1.792151E−01 | −8.222620E−02 | −3.868525E−02 |
| A10 | 8.415258E−02 | −1.574090E−01 | 4.551919E−01 | 1.708219E−01 | 5.285323E−02 | 1.600830E−02 |
| A12 | −1.007374E−01 | 1.673150E−01 | −3.827412E−01 | −1.085936E−01 | −2.487962E−02 | −4.702110E−03 |
| A14 | 8.033670E−02 | −1.061897E−01 | 2.142301E−01 | 4.812275E−02 | 8.326661E−03 | 9.732173E−04 |
| A16 | −4.063921E−02 | 3.952956E−02 | −7.569350E−02 | −1.409158E−02 | −1.803138E−03 | −1.273903E−04 |
| A18 | 1.158819E−02 | −8.024934E−03 | 1.502453E−02 | 2.382458E−03 | 2.197925E−04 | 9.028992E−06 |
| A20 | −1.431842E−03 | 6.805029E−04 | −1.263730E−03 | −1.722129E−04 | −1.125818E−05 | −2.543390E−07 |

| | 14th Surface | 15th Surface | 16th Surface | 17th Surface |
|---|---|---|---|---|
| k | −9.713821E−01 | 3.799134E−02 | −9.338357E−01 | −7.460846E+00 |
| A4 | −4.457328E−02 | −3.694813E−02 | −1.270198E−01 | −5.376165E−02 |
| A6 | 1.554802E−02 | 9.653296E−03 | 4.893243E−02 | 1.780326E−02 |
| A8 | −9.696301E−03 | −5.951172E−03 | −1.369234E−02 | −4.159037E−03 |
| A10 | 3.101693E−03 | 2.119119E−03 | 2.395158E−03 | 5.959389E−04 |
| A12 | −5.736615E−04 | −4.723484E−04 | −2.568692E−04 | −5.403407E−05 |
| A14 | 5.319648E−05 | 6.758265E−05 | 1.695456E−05 | 3.172843E−06 |
| A16 | −2.365982E−07 | −6.051745E−06 | −6.683562E−07 | −1.181822E−07 |
| A18 | −3.292743E−07 | 3.086265E−07 | 1.423040E−08 | 2.559822E−09 |
| A20 | 1.693206E−08 | −6.813902E−09 | −1.223130E−10 | −2.480858E−11 |

As illustrated in FIG. 4, the imaging lens according to Example 2 is also capable of satisfactorily correcting the aberrations.

### Example 3

The basic lens data is shown below.

TABLE 5
Example 3
Unit mm

f = 7.748
Fno = 2.29
ω(°) = 36.8
h = 5.8
TTL = 8.36

Surface Data

| i | r | d | nd | νd | |
|---|---|---|---|---|---|
| (Object) | Infinity | Infinity | | | |
| 1 (Stop) | Infinity | −0.533 | | | |
| 2* | 2.701 | 0.662 | 1.544 | 56.44 | (νd1) |
| 3* | 7.483 | 0.057 | | | |
| 4* | 3.808 | 0.250 | 1.671 | 19.24 | (νd2) |
| 5* | 2.805 | 0.194 | | | |
| 6* | 5.401 | 0.636 | 1.544 | 56.44 | (νd3) |
| 7* | 13.929 | 0.621 | | | |
| 8* | −25.444 | 0.350 | 1.544 | 56.44 | (νd4) |
| 9* | −17.540 | 0.943 | | | |
| 10* | −3.791 | 0.432 | 1.671 | 19.24 | (νd5) |
| 11* | −3.755 | 0.072 | | | |
| 12* | −6.277 | 0.495 | 1.535 | 55.69 | (νd6) |
| 13* | −18.171 | 0.174 | | | |
| 14* | 5.908 | 0.536 | 1.535 | 55.69 | (νd7) |
| 15* | 5.154 | 0.202 | | | |
| 16* | 2.368 | 0.741 | 1.535 | 55.69 | (νd8) |
| 17* | 1.969 | 0.400 | | | |
| 18 | Infinity | 0.210 | 1.517 | 64.20 | |
| 19 | Infinity | 1.454 | | | |
| Image Plane | | | | | |

Constituent Lens Data

| Lens | Start Surface | Focal Length | Total Track/Diagonal Ratio |
|---|---|---|---|
| L1 | 2 | 7.400 | 0.72 |
| L2 | 4 | −17.631 | |
| L3 | 6 | 15.786 | |
| L4 | 8 | 102.117 | |
| L5 | 10 | 100.964 | |
| L6 | 12 | −18.193 | |
| L7 | 14 | −100.457 | |
| L8 | 16 | −62.013 | |

TABLE 6
Aspheric Surface Data

| | 2nd Surface | 3rd Surface | 4th Surface | 5th Surface | 6th Surface | 7th Surface |
|---|---|---|---|---|---|---|
| k | −7.382325E−01 | 0.000000E+00 | −1.157907E+00 | −3.244572E+00 | 0.000000E+00 | 0.000000E+00 |
| A4 | 2.595054E−03 | −2.248834E−02 | −4.575358E−02 | −5.646240E−03 | 2.135371E−02 | −5.570485E−03 |
| A6 | 4.914435E−03 | 4.639951E−02 | 5.232507E−02 | 1.618055E−02 | −1.685817E−02 | 2.789891E−02 |
| A8 | −6.702480E−05 | −3.548537E−02 | −4.230996E−02 | −3.357329E−02 | 3.051440E−02 | −5.742159E−02 |
| A10 | −6.502318E−03 | 8.886543E−03 | 1.408071E−02 | 5.844276E−02 | −2.189174E−02 | 7.227491E−02 |
| A12 | 8.261610E−03 | 8.254209E−03 | 6.576839E−03 | −6.358531E−02 | 3.299945E−03 | −5.136771E−02 |
| A14 | −4.946842E−03 | −8.520048E−03 | −8.382800E−03 | 4.275879E−02 | 6.579599E−03 | 1.909391E−02 |
| A16 | 1.613189E−03 | 3.503119E−03 | 3.499135E−03 | −1.698665E−02 | −4.798421E−03 | −2.161995E−03 |
| A18 | −2.745511E−04 | −7.272045E−04 | −7.030256E−04 | 3.632988E−03 | 1.312609E−03 | −6.626257E−04 |
| A20 | 1.868099E−05 | 6.174599E−05 | 5.672422E−05 | −3.221941E−04 | −1.305100E−04 | 1.646418E−04 |
| | 8th Surface | 9th Surface | 10th Surface | 11th Surface | 12th Surface | 13th Surface |
| k | 0.000000E+00 | 0.000000E+00 | 0.000000E+00 | 0.000000E+00 | 0.000000E+00 | 0.000000E+00 |
| A4 | −4.622151E−02 | −4.468566E−02 | −8.058447E−02 | −6.638592E−02 | 4.174843E−02 | 5.172567E−04 |
| A6 | 3.446686E−03 | 1.030448E−02 | 4.289776E−02 | 4.826004E−02 | −4.046692E−04 | 1.627781E−02 |
| A8 | −1.164336E−02 | −8.429890E−03 | −1.832724E−02 | −2.648237E−02 | −1.349924E−02 | −1.000654E−02 |
| A10 | 1.422992E−02 | −6.638808E−03 | −1.039570E−03 | 4.904156E−03 | 8.010481E−03 | 2.415892E−03 |
| A12 | −9.428431E−03 | 1.905957E−02 | 6.979319E−03 | 3.373890E−03 | −2.658690E−03 | −2.290642E−04 |
| A14 | 1.216068E−03 | −1.665104E−02 | 4.009332E−03 | −2.487649E−03 | 5.704376E−04 | −1.644419E−05 |
| A16 | 2.142436E−03 | 7.493225E−03 | 1.005541E−03 | 6.955288E−04 | −8.137946E−05 | 6.110158E−06 |
| A18 | −1.164827E−03 | −1.746522E−03 | −1.028249E−04 | −9.299344E−05 | 6.861876E−06 | −5.525318E−07 |
| A20 | 1.829338E−04 | 1.676725E−04 | 1.303807E−06 | 4.934287E−06 | −2.420378E−07 | 1.776814E−08 |

| | 14th Surface | 15th Surface | 16th Surface | 17th Surface |
|---|---|---|---|---|
| k | 7.839023E−03 | 0.000000E+00 | −1.163838E+00 | 4.599943E+00 |
| A4 | −2.481340E−02 | −2.773611E−03 | −1.022468E−01 | −5.068882E−02 |
| A6 | 1.008596E−02 | −1.964511E−03 | 3.081364E−02 | 1.284545E−02 |
| A8 | −6.609336E−03 | −1.539822E−03 | −7.601681E−03 | −2.657499E−03 |
| A10 | 2.217032E−03 | 7.344577E−04 | 1.256520E−03 | 3.704718E−04 |
| A12 | 4.586046E−04 | −1.543847E−04 | −1.310234E−04 | −3.273522E−05 |
| A14 | 5.898926E−05 | 1.813609E−05 | 8.550556E−06 | 1.819076E−06 |
| A16 | 4.487001E−06 | −1.208899E−06 | −3.398424E−07 | −6.210912E−08 |
| A18 | 1.837020E−07 | 4.267427E−08 | 7.546011E−09 | 1.195896E−09 |
| A20 | −3.120251E−09 | −6.197474E−10 | −7.206911E−11 | −9.929040E−12 |

As illustrated in FIG. 6, the imaging lens according to Example 3 is also capable of satisfactorily correcting the aberrations.

### Example 4

The basic lens data is shown below.

TABLE 7
Example 4
Unit mm

f = 7.757
Fno = 2.29
ω(°) = 36.6
h = 5.8
TTL = 8.37

Surface Data

| i | r | d | nd | νd | |
|---|---|---|---|---|---|
| (Object) | Infinity | Infinity | | | |
| 1 (Stop) | Infinity | −0.497 | | | |
| 2* | 2.739 | 0.662 | 1.544 | 56.44 | (νd1) |
| 3* | 7.703 | 0.062 | | | |
| 4* | 3.830 | 0.250 | 1.671 | 19.24 | (νd2) |
| 5* | 2.820 | 0.204 | | | |
| 6* | 5.309 | 0.595 | 1.544 | 56.44 | (νd3) |
| 7* | 13.459 | 0.649 | | | |
| 8* | −48.235 | 0.376 | 1.544 | 56.44 | (νd4) |
| 9* | −25.758 | 0.951 | | | |
| 10* | −3.845 | 0.436 | 1.671 | 19.24 | (νd5) |
| 11* | −3.753 | 0.018 | | | |
| 12* | −9.173 | 0.469 | 1.535 | 55.69 | (νd6) |
| 13* | 100.537 | 0.223 | | | |
| 14* | 6.223 | 0.571 | 1.535 | 55.69 | (νd7) |
| 15* | 5.400 | 0.161 | | | |
| 16* | 2.376 | 0.755 | 1.535 | 55.69 | (νd8) |
| 17* | 2.023 | 0.400 | | | |
| 18 | Infinity | 0.210 | 1.517 | 64.20 | |
| 19 | Infinity | 1.445 | | | |
| Image Plane | | | | | |

Constituent Lens Data

| Lens | Start Surface | Focal Length | Total Track/Diagonal Ratio |
|---|---|---|---|
| L1 | 2 | 7.458 | 0.73 |
| L2 | 4 | −17.702 | |
| L3 | 6 | 15.700 | |
| L4 | 8 | 100.930 | |
| L5 | 10 | 80.505 | |
| L6 | 12 | −15.695 | |
| L7 | 14 | −100.746 | |
| L8 | 16 | −99.560 | |

TABLE 8
Aspheric Surface Data

| | 2nd Surface | 3rd Surface | 4th Surface | 5th Surface | 6th Surface | 7th Surface |
|---|---|---|---|---|---|---|
| k | −7.537313E−01 | 0.000000E+00 | −1.139773E +00 | −3.263386E+00 | 0.000000E+00 | 0.000000E+00 |
| A4 | 2.492508E−03 | −2.263060E−02 | −4.571164E−02 | −5.617621E−03 | 2.156856E−02 | −5.611755E−03 |
| A6 | 4.855054E−03 | 4.634166E−02 | 5.232048E−02 | 1.626561E−02 | −1.674971E−02 | 2.796876E−02 |
| A8 | −8.345356E−05 | −3.552585E−02 | −4.229342E−02 | −3.355860E−02 | 3.054775E−02 | −5.733351E−02 |
| A10 | −6.508609E−03 | 8.870185E−03 | 1.408943E−02 | 5.843856E−02 | −2.188844E−02 | 7.231974E−02 |
| A12 | 8.258982E−03 | 8.249084E−03 | 6.579546E−03 | −6.358951E−02 | 3.291114E−03 | −5.135539E−02 |
| A14 | −4.947539E−03 | −8.521103E−03 | −8.382816E−03 | 4.275669E−02 | 6.573988E−03 | 1.909344E−02 |
| A16 | 1.613110E−03 | 3.503130E−03 | 3.498830E−03 | −1.698727E−02 | −4.801088E−03 | −2.164625E−03 |
| A18 | −2.745124E−04 | −7.270678E−04 | −7.031838E−04 | 3.632925E−03 | 1.312491E−03 | −6.645505E−04 |
| A20 | 1.869648E−05 | 6.185499E−05 | 5.675484E−05 | −3.222677E−04 | −1.302288E−04 | 1.639725E−04 |
| | 8th Surface | 9th Surface | 10th Surface | 11th Surface | 12th Surface | 13th Surface |
| k | 0.000000E+00 | 0.000000E+00 | 0.000000E+00 | 0.000000E+00 | 0.000000E+00 | 0.000000E+00 |
| A4 | −4.608980E−02 | −4.466752E−02 | −8.050286E−02 | −6.564754E−02 | 3.954281E−02 | −1.832983E−03 |
| A6 | 3.760150E−03 | 1.029006E−02 | 4.284749E−02 | 4.820724E−02 | −5.588346E−04 | 1.622007E−02 |
| A8 | −1.154539E−02 | −8.436665E−03 | −1.834566E−02 | −2.651631E−02 | −1.350033E−02 | −9.995997E−03 |
| A10 | 1.423280E−02 | −6.647592E−03 | −1.045596E−03 | 4.898336E−03 | 8.010733E−03 | 2.417250E−03 |
| A12 | −9.439507E−03 | 1.905685E−02 | 6.978893E−03 | 3.373231E−03 | −2.658792E−03 | −2.289795E−04 |
| A14 | 1.209353E−03 | −1.665392E−02 | −4.009379E−03 | −2.487631E−03 | 5.704287E−04 | −1.644673E−05 |
| A16 | 2.138257E−03 | 7.492129E−03 | 1.005452E−03 | 6.955404E−04 | −8.137717E−05 | 6.109026E−06 |
| A18 | −1.165998E−03 | −1.747217E−03 | −1.028962E−04 | −9.298546E−05 | 6.862196E−06 | −5.527009E−07 |
| A20 | 1.819572E−04 | 1.674188E−04 | 1.287881E−06 | 4.935752E−06 | −2.420454E−07 | 1.774815E−08 |

| | 14th Surface | 15th Surface | 16th Surface | 17th Surface |
|---|---|---|---|---|
| k | −2.061106E−03 | 0.000000E+00 | −1.164547E+00 | −4.827592E+00 |
| A4 | −2.482190E−02 | −2.728174E−03 | −1.022271E−01 | −5.086109E−02 |
| A6 | 1.009171E−02 | −1.970446E−03 | 3.081465E−02 | 1.286508E−02 |
| A8 | −6.608356E−03 | −1.540481E−03 | −7.601579E−03 | −2.657167E−03 |
| A10 | 2.217094E−03 | 7.344513E−04 | 1.256521E−03 | 3.704601E−04 |
| A12 | −4.586002E−04 | −1.543826E−04 | −1.310236E−04 | −3.273616E−05 |
| A14 | 5.898955E−05 | 1.813638E−05 | 8.550547E−06 | 1.819040E−06 |
| A16 | −4.486976E−06 | −1.208875E−06 | −3.398416E−07 | −6.210935E−08 |
| A18 | 1.837032E−07 | 4.267634E−08 | 7.546170E−09 | 1.195999E−09 |
| A20 | −3.120266E−09 | −6.197390E−10 | −7.204583E−11 | −9.917573E−12 |

As illustrated in FIG. 8, the imaging lens according to Example 4 is also capable of satisfactorily correcting the aberrations.

### Example 5

The basic lens data is shown below.

TABLE 9
Example 5
Unit mm

f = 7.137
Fno = 1.97
ω(°) = 39.1
h = 5.8
TTL = 7.62

Surface Data

| i | r | d | nd | νd | |
|---|---|---|---|---|---|
| (Object) | Infinity | Infinity | | | |
| 1 (Stop) | Infinity | −0.659 | | | |
| 2* | 2.494 | 0.847 | 1.544 | 56.44 | (νd1) |
| 3* | 5.543 | 0.022 | | | |
| 4* | 3.504 | 0.200 | 1.671 | 19.24 | (νd2) |
| 5* | 2.822 | 0.115 | | | |
| 6* | 5.002 | 0.486 | 1.544 | 56.44 | (νd3) |
| 7* | 10.312 | 0.474 | | | |
| 8* | 103.742 | 0.366 | 1.588 | 28.36 | (νd4) |
| 9* | −120.578 | 0.424 | | | |
| 10* | −10.434 | 0.282 | 1.671 | 19.24 | (νd5) |
| 11* | −19.544 | 0.458 | | | |
| 12* | −8.314 | 0.527 | 1.567 | 37.40 | (νd6) |
| 13* | −6.069 | 0.076 | | | |
| 14* | 3.796 | 0.490 | 1.535 | 55.69 | (νd7) |
| 15* | 3.388 | 0.990 | | | |
| 16* | 3.725 | 0.609 | 1.535 | 55.69 | (νd8) |
| 17* | 2.032 | 0.400 | | | |
| 18 | Infinity | 0.210 | 1.517 | 64.20 | |
| 19 | Infinity | 0.715 | | | |
| Image Plane | | | | | |

Constituent Lens Data

| Lens | Start Surface | Focal Length | Total Track/Diagonal Ratio |
|---|---|---|---|
| L1 | 2 | 7.585 | 0.66 |
| L2 | 4 | −24.529 | |
| L3 | 6 | 17.287 | |
| L4 | 8 | 94.972 | |
| L5 | 10 | −33.793 | |
| L6 | 12 | 36.524 | |
| L7 | 14 | −101.456 | |
| L8 | 16 | −9.557 | |

TABLE 10
Aspheric Surface Data

| | 2nd Surface | 3rd Surface | 4th Surface | 5th Surface | 6th Surface | 7th Surface |
|---|---|---|---|---|---|---|
| k | −7.678324E−01 | 0.000000E+00 | −3.449009E+00 | −2.203929E+00 | 0.000000E+00 | 0.000000E+00 |
| A4 | −9.426564E−04 | −5.868388E−02 | −8.172448E−02 | −1.438360E−02 | 1.342590E−02 | −1.027235E−02 |
| A6 | 1.876800E−02 | 1.377907E−01 | 2.108099E−01 | 6.677234E−02 | 1.620744E−02 | 4.535216E−02 |
| A8 | −2.887927E−02 | −1.923422E−01 | −3.727182E−01 | −1.706359E−01 | −4.090032E−02 | −1.167071E−01 |
| A10 | 2.705698E−02 | 1.541056E−01 | 3.805501E−01 | 2.035697E−01 | 5.048637E−02 | 1.935125E−01 |
| A12 | −1.575031E−02 | −6.817743E−02 | −2.333819E−01 | −1.420319E−01 | −4.432481E−02 | −1.882070E−01 |
| A14 | 5.671387E−03 | 1.458741E−02 | 8.793665E−02 | 6.507920E−02 | 3.416684E−02 | 1.110261E−01 |
| A16 | −1.213197E−03 | −4.538379E−04 | −2.001584E−02 | −2.031112E−02 | −1.801425E−02 | −3.812372E−02 |
| A18 | 1.385263E−04 | −3.566875E−04 | 2.542332E−03 | 3.999454E−03 | 5.153275E−03 | 6.888995E−03 |
| A20 | −6.518064E−06 | 4.492985E−05 | −1.395531E−04 | −3.668823E−04 | −6.007796E−04 | −5.109425E−04 |
| | 8th Surface | 9th Surface | 10th Surface | 11th Surface | 12th Surface | 13th Surface |
| k | 0.000000E+00 | 0.000000E+00 | 0.000000E+00 | 0.000000E+00 | 0.000000E+00 | 0.000000E+00 |
| A4 | −5.242269E−03 | −4.997791E−02 | −6.821358E−02 | −8.166977E−02 | −3.773668E−02 | −2.487508E−02 |
| A6 | −1.280052E−01 | 1.003943E−01 | 2.259293E−02 | 9.820865E−02 | 3.858291E−02 | 5.202102E−03 |
| A8 | 3.769462E−01 | −2.959649E−01 | 3.851250E−02 | −1.313070E−01 | −2.440172E−02 | 1.484541E−02 |
| A10 | −6.763195E−01 | 5.004899E−01 | −1.663544E−01 | 1.106894E−01 | 4.026466E−03 | −1.904470E−02 |
| A12 | 7.651387E−01 | −5.206177E−01 | 2.294892E−01 | −6.321432E−02 | 1.417135E−03 | 9.907323E−03 |
| A14 | −5.417818E−01 | 3.410942E−01 | −1.686284E−01 | 2.604434E−02 | −4.641363E−04 | −2.806325E−03 |
| A16 | 2.331742E−01 | −1.366907E−01 | 7.130677E−02 | −7.487663E−03 | −5.534771E−05 | 4.577821E−04 |
| A18 | −5.576689E−02 | 3.049965E−02 | −1.654629E−02 | 1.293884E−03 | 3.202337E−05 | −4.062499E−05 |
| A20 | 5.669571E−03 | −2.902004E−03 | 1.636619E−03 | −9.665510E−05 | −2.908258E−06 | 1.523871E−06 |

| | 14th Surface | 15th Surface | 16th Surface | 17th Surface |
|---|---|---|---|---|
| k | −1.787744E+00 | 5.721328E−02 | −1.747453E+00 | −6.894790E+00 |
| A4 | −3.195879E−02 | −3.485657E−02 | −1.204535E−01 | −5.672357E−02 |
| A6 | −5.993506E−03 | 3.830700E−03 | 4.455185E−02 | 1.749477E−02 |
| A8 | 7.366507E−03 | −1.850795E−03 | −1.175377E−02 | −3.545990E−03 |
| A10 | −4.776180E−03 | 4.813153E−04 | 1.982407E−03 | 3.892757E−04 |
| A12 | 1.624520E−03 | −7.286611E−05 | −2.131597E−04 | −1.833775E−05 |
| A14 | −3.124610E−04 | 6.270026E−06 | 1.486548E−05 | −3.680757E−07 |
| A16 | 3.469416E−05 | −2.633811E−07 | −6.608196E−07 | 8.397994E−08 |
| A18 | −2.070094E−06 | 2.398501E−09 | 1.715206E−08 | −3.612176E−09 |
| A20 | 5.122419E−08 | 1.113063E−1.0 | −1.980666E−1.0 | 5.332049E−11 |

As illustrated in FIG. 10, the imaging lens according to Example 5 is also capable of satisfactorily correcting the aberrations.

### Example 6

The basic lens data is shown below.

TABLE 11
Example 6
Unit mm

f = 7.127
Fno = 1.95
ω(°) = 39.1
h = 5.8
TTL = 7.72

Surface Data

| i | r | d | nd | νd | |
|---|---|---|---|---|---|
| (Object) | Infinity | Infinity | | | |
| 1 (Stop) | Infinity | −0.735 | | | |
| 2* | 2.495 | 0.918 | 1.544 | 56.44 | (νd1) |
| 3* | 5.683 | 0.020 | | | |
| 4* | 3.556 | 0.240 | 1.671 | 19.24 | (νd2) |
| 5* | 3.215 | 0.121 | | | |
| 6* | 8.140 | 0.465 | 1.544 | 56.44 | (νd3) |
| 7* | 12.219 | 0.357 | | | |
| 8* | 14.648 | 0.317 | 1.588 | 28.36 | (νd4) |
| 9* | 22.405 | 0.523 | | | |
| 10* | −4.737 | 0.343 | 1.671 | 19.24 | (νd5) |
| 11* | −15.212 | 0.283 | | | |
| 12* | −41.850 | 0.539 | 1.567 | 37.40 | (νd6) |
| 13* | −4.233 | 0.316 | | | |
| 14* | 4.847 | 0.378 | 1.535 | 55.69 | (νd7) |
| 15* | 3.251 | 0.854 | | | |
| 16* | 2.747 | 0.614 | 1.535 | 55.69 | (νd8) |
| 17* | 1.831 | 0.400 | | | |
| 18 | Infinity | 0.210 | 1.517 | 64.20 | |
| 19 | Infinity | 0.893 | | | |
| Image Plane | | | | | |

Constituent Lens Data

| Lens | Start Surface | Focal Length | Total Track/Diagonal Ratio |
|---|---|---|---|
| L1 | 2 | 7.414 | 0.67 |
| L2 | 4 | −69.637 | |
| L3 | 6 | 43.060 | |
| L4 | 8 | 70.932 | |
| L5 | 10 | −10.393 | |
| L6 | 12 | 8.261 | |
| L7 | 14 | −20.127 | |
| L8 | 16 | −13.394 | |

TABLE 12
Aspheric Surface Data

| | 2nd Surface | 3rd Surface | 4th Surface | 5th Surface | 6th Surface | 7th Surface |
|---|---|---|---|---|---|---|
| k | −6.729113E−01 | 0.000000E+00 | −3.378682E+00 | −2.129958E+00 | 0.000000E+00 | 0.000000E+00 |
| A4 | 1.409360E−05 | −5.960123E−02 | −8.158780E−02 | −1.424118E−02 | 1.491780E−02 | −9.993334E−03 |
| A6 | 1.894258E−02 | 1.377814E−01 | 2.107417E−01 | 6.676904E−02 | 1.671984E−02 | 4.492418E−02 |
| A8 | −2.887254E−02 | −1.922700E−01 | −3.727999E−01 | −1.705121E−01 | 4.087517E−02 | −1.169766E−01 |
| A10 | 2.705695E−02 | 1.541340E−01 | 3.805338E−01 | 2.036161E−01 | 5.047999E−02 | 1.934111E−01 |
| A12 | 1.574912E−02 | −6.816982E−02 | −2.333834E−01 | −1.420257E−01 | 4.431710E−02 | −1.882259E−01 |
| A14 | 5.672113E−03 | 1.458934E−02 | 8.793804E−02 | 6.507735E−02 | 3.417127E−02 | 1.110257E−01 |
| A16 | −1.213072E−03 | 4.535188E−04 | −2.001513E−02 | −2.031255E−02 | −1.801215E−02 | −3.812382E−02 |
| A18 | 1.385668E−04 | −3.566638E−04 | 2.542428E−03 | 3.999547E−03 | 5.153646E−03 | 6.889012E−03 |
| A20 | −6.506137E−06 | 4.492290E−05 | −1.394404E−04 | −3.673168E−04 | −6.004337E−04 | −5.118608E−04 |
| | 8th Surface | 9th Surface | 10th Surface | 11th Surface | 12th Surface | 13th Surface |
| k | 0.000000E+00 | 0.000000E+00 | 0.000000E+00 | 0.000000E+00 | 0.000000E+00 | 0.000000E+00 |
| A4 | 7.103850E−03 | 4.834380E−02 | −6.734438E−02 | −8.384082E−02 | 4.120708E−02 | −2.075878E−02 |
| A6 | −1.289188E−01 | 1.019691E−01 | 1.949090E−02 | 9.784984E−02 | 3.846579E−02 | 6.268063E−03 |
| A8 | 3.770568E−01 | −2.962333E−01 | 3.966818E−02 | −1.318154E−01 | −2.417267E−02 | 1.478261E−02 |
| A10 | −6.763054E−01 | 5.001890E−01 | −1.660182E−01 | 1.106692E−01 | 4.014843E−03 | −1.904829E−02 |
| A12 | 7.650976E−01 | −5.206464E−01 | 2.294111E−01 | −6.318351E−02 | 1.410008E−03 | 9.907587E−03 |
| A14 | −5.418081E−01 | 3.411192E−01 | −1.687259E−01 | 2.605744E−02 | 4.658829E−04 | −2.806266E−03 |
| A16 | 2.331550E−01 | −1.366640E−01 | 7.127368E−02 | −7.485537E−03 | −5.552457E−05 | 4.577839E−04 |
| A18 | −5.576532E−02 | 3.050300E−02 | −1.654686E−02 | 1.293651E−03 | 3.202849E−05 | 4.062412E−05 |
| A20 | 5.666847E−03 | −2.909421E−03 | 1.654149E−03 | −9.695767E−05 | −2.892243E−06 | 1.522778E−06 |

| | 14th Surface | 15th Surface | 16th Surface | 17th Surface |
|---|---|---|---|---|
| k | −3.018838E−01 | 3.304528E−02 | −1.980831E+00 | −5.579356E+00 |
| A4 | −3.009677E−02 | −3.698509E−02 | −1.217819E−01 | −5.913706E−02 |
| A6 | −6.204797E−03 | 3.963106E−03 | 4.449840E−02 | 1.748376E−02 |
| A8 | 7.374696E−03 | −1.860271E−03 | −1.175256E−02 | −3.543442E−03 |
| A10 | 4.776290E−03 | 4.806167E−04 | 1.982514E−03 | 3.894808E−04 |
| A12 | 1.624420E−03 | −7.292134E−05 | −2.131550E−04 | −1.833565E−05 |
| A14 | −3.124858E−04 | 6.262590E−06 | 1.486557E−05 | −3.683636E−07 |
| A16 | 3.469030E−05 | −2.645157E−07 | −6.608258E−07 | 8.395342E−08 |
| A18 | −2.070112E−06 | 2.377648E−09 | 1.715205E−08 | −3.612228E−09 |
| A20 | 5.114422E−08 | 9.272855E−11 | −1.981619E−10 | 5.328224E−11 |

As illustrated in FIG. 12, the imaging lens according to Example 6 is also capable of satisfactorily correcting the aberrations.

### Example 7

The basic lens data is shown below.

TABLE 13
Example 7
Unit mm

f = 7.138
Fno = 1.97
ω(°) = 39.1
h = 5.8
TTL = 7.67

Surface Data

| i | r | d | nd | νd | |
|---|---|---|---|---|---|
| (Object) | Infinity | Infinity | | | |
| 1 (Stop) | Infinity | −0.658 | | | |
| 2* | 2.501 | 0.845 | 1.544 | 56.44 | (νd1) |
| 3* | 5.558 | 0.037 | | | |
| 4* | 3.563 | 0.200 | 1.671 | 19.24 | (νd2) |
| 5* | 2.851 | 0.083 | | | |
| 6* | 5.000 | 0.485 | 1.544 | 56.44 | (νd3) |
| 7* | 10.253 | 0.477 | | | |
| 8* | 66.247 | 0.354 | 1.588 | 28.36 | (νd4) |
| 9* | −383.561 | 0.425 | | | |
| 10* | −9.663 | 0.282 | 1.671 | 19.24 | (νd5) |
| 11* | −17.010 | 0.456 | | | |
| 12* | −7.632 | 0.586 | 1.567 | 37.40 | (νd6) |
| 13* | −5.622 | 0.061 | | | |
| 14* | 3.795 | 0.496 | 1.567 | 37.40 | (νd7) |
| 15* | 3.401 | 0.952 | | | |
| 16* | 3.666 | 0.639 | 1.535 | 55.69 | (νd8) |
| 17* | 2.045 | 0.400 | | | |
| 18 | Infinity | 0.210 | 1.517 | 64.20 | |
| 19 | Infinity | 0.751 | | | |
| Image Plane | | | | | |

Constituent Lens Data

| Lens | Start Surface | Focal Length | Total Track/Diagonal Ratio |
|---|---|---|---|
| L1 | 2 | 7.611 | 0.67 |
| L2 | 4 | −23.989 | |
| L3 | 6 | 17.360 | |
| L4 | 8 | 96.178 | |
| L5 | 10 | −33.875 | |
| L6 | 12 | 34.052 | |
| L7 | 14 | −105.807 | |
| L8 | 16 | −10.027 | |

TABLE 14
Aspheric Surface Data

| | 2nd Surface | 3rd Surface | 4th Surface | 5th Surface | 6th Surface | 7th Surface |
|---|---|---|---|---|---|---|
| k | −7.956966E−01 | 0.000000E+00 | −3.524953E+00 | −2.088070E+00 | 0.000000E+00 | 0.000000E+00 |
| A4 | −1.234717E−03 | −5.880331E−02 | −8.157543E−02 | −1.415519E−02 | 1.343446E−02 | −1.035453E−02 |
| A6 | 1.891351E−02 | 1.376900E−01 | 2.109302E−01 | 6.661214E−02 | 1.620539E−02 | 4.545828E−02 |
| A8 | −2.886406E−02 | −1.922991E−01 | −3.727422E−01 | −1.706109E−01 | −4.096613E−02 | −1.167288E−01 |
| A10 | 2.705237E−02 | 1.541183E−01 | 3.805466E−01 | 2.035731E−01 | 5.049060E−02 | 1.934812E−01 |
| A12 | −1.575220E−02 | −6.817591E−02 | −2.333798E−01 | −1.420345E−01 | −4.431526E−02 | −1.882112E−01 |
| A14 | 5.671211E−03 | 1.458760E−02 | 8.793749E−02 | 6.507801E−02 | 3.416780E−02 | 1.110285E−01 |
| A16 | −1.213223E−03 | −4.538479E−04 | −2.001561E−02 | −2.031100E−02 | −1.801559E−02 | −3.812267E−02 |
| A18 | 1.385668E−04 | −3.566638E−04 | 2.542428E−03 | 3.999547E−03 | 5.153646E−03 | 6.889012E−03 |
| A20 | −6.502239E−06 | 4.492088E−05 | −1.395319E−04 | −3.668610E−04 | −6.014455E−04 | −5.111839E−04 |
| | 8th Surface | 9th Surface | 10th Surface | 11th Surface | 12th Surface | 13th Surface |
| k | 0.000000E+00 | 0.000000E+00 | 0.000000E+00 | 0.000000E+00 | 0.000000E+00 | 0.000000E+00 |
| A4 | −5.906900E−03 | −5.184246E−02 | −6.534825E−02 | −8.176653E−02 | −3.603953E−02 | −2.518303E−02 |
| A6 | −1.284463E−01 | 1.007512E−01 | 2.049633E−02 | 9.914289E−02 | 3.830278E−02 | 5.434798E−03 |
| A8 | 3.769453E−01 | −2.961565E−01 | 3.933448E−02 | −1.314641E−01 | −2.424943E−02 | 1.480135E−02 |
| A10 | −6.763744E−01 | 5.003866E−01 | −1.662138E−01 | 1.106853E−01 | 4.025597E−03 | −1.904611E−02 |
| A12 | 7.651127E−01 | −5.206123E−01 | 2.295134E−01 | −6.319899E−02 | 1.414530E−03 | 9.907437E−03 |
| A14 | −5.417774E−01 | 3.410934E−01 | −1.686617E−01 | 2.604953E−02 | −4.648168E−04 | −2.806318E−03 |
| A16 | 2.331769E−01 | −1.366863E−01 | 7.129400E−02 | −7.487188E−03 | −5.543150E−05 | 4.577823E−04 |
| A18 | −5.576532E−02 | 3.050300E−02 | −1.654686E−02 | 1.293651E−03 | 3.202849E−05 | −4.062412E−05 |
| A20 | 5.670593E−03 | −2.903609E−03 | 1.640810E−03 | −9.681271E−05 | −2.902585E−06 | 1.524003E−06 |

| | 14th Surface | 15th Surface | 16th Surface | 17th Surface |
|---|---|---|---|---|
| k | −1.908266E+00 | 5.522089E−02 | −1.582795E+00 | −6.498589E+00 |
| A4 | −3.213106E−02 | −3.507362E−02 | −1.204218E−01 | −5.684505E−02 |
| A6 | −6.011119E−03 | 3.846891E−03 | 4.454061E−02 | 1.749812E−02 |
| A8 | 7.369816E−03 | −1.846941E−03 | −1.175361E−02 | −3.546030E−03 |
| A10 | 4.775959E−03 | 4.816805E−04 | 1.982398E−03 | 3.892993E−04 |
| A12 | 1.624533E−03 | −7.284630E−05 | −2.131601E−04 | −1.833710E−05 |
| A14 | −3.124624E−04 | 6.270752E−06 | 1.486542E−05 | −3.680444E−07 |
| A16 | 3.469435E−05 | −2.634481E−07 | −6.608200E−07 | 8.397903E−08 |
| A18 | −2.070112E−06 | 2.377648E−09 | 1.715205E−08 | −3.612228E−09 |
| A20 | 5.121992E−08 | 1.087916E−1.0 | −1.980394E−1.0 | 5.330919E−11 |

As illustrated in FIG. 14, the imaging lens according to Example 7 is also capable of satisfactorily correcting the aberrations.

### Example 8

The basic lens data is shown below.

TABLE 15
Example 8
Unit mm

f = 7.680
Fno = 2.30
ω(°) = 37.1
h = 5.8
TTL = 8.36

Surface Data

| i | r | d | nd | νd | |
|---|---|---|---|---|---|
| (Object) | Infinity | Infinity | | | |
| 1 (Stop) | Infinity | −0.550 | | | |
| 2* | 2.706 | 0.675 | 1.544 | 56.44 | (νd1) |
| 3* | 8.525 | 0.070 | | | |
| 4* | 3.761 | 0.229 | 1.671 | 19.24 | (νd2) |
| 5* | 2.839 | 0.187 | | | |
| 6* | 5.580 | 0.669 | 1.544 | 56.44 | (νd3) |
| 7* | 16.901 | 0.653 | | | |
| 8* | −11.753 | 0.653 | 1.544 | 56.44 | (νd4) |
| 9* | −11.485 | 0.867 | | | |
| 10* | −4.360 | 0.505 | 1.671 | 19.24 | (νd5) |
| 11* | −5.246 | 0.029 | | | |
| 12* | −11.228 | 0.561 | 1.535 | 55.69 | (νd6) |
| 13* | −85.631 | 0.101 | | | |
| 14* | 7.223 | 0.575 | 1.535 | 55.69 | (νd7) |
| 15* | 5.784 | 0.164 | | | |
| 16* | 2.505 | 0.754 | 1.535 | 55.69 | (νd8) |
| 17* | 2.070 | 0.400 | | | |
| 18 | Infinity | 0.210 | 1.517 | 64.20 | |
| 19 | Infinity | 1.125 | | | |
| Image Plane | | | | | |

Constituent Lens Data

| Lens | Start Surface | Focal Length | Total Track/Diagonal Ratio |
|---|---|---|---|
| L1 | 2 | 6.995 | 0.73 |
| L2 | 4 | −19.173 | |
| L3 | 6 | 14.990 | |
| L4 | 8 | 498.293 | |
| L5 | 10 | −49.947 | |
| L6 | 12 | −24.227 | |
| L7 | 14 | −63.055 | |
| L8 | 16 | −56.016 | |

TABLE 16
Aspheric Surface Data

| | 2nd Surface | 3rd Surface | 4th Surface | 5th Surface | 6th Surface | 7th Surface |
|---|---|---|---|---|---|---|
| k | −7.695523E−01 | 0.000000E+00 | −1.142922E+00 | −3.343364E+00 | 0.000000E+00 | 0.000000E+00 |
| A4 | 2.425810E−03 | −2.272001E−02 | −4.570103E−02 | −5.584398E−03 | 2.127086E−02 | −6.174993E−03 |
| A6 | 4.831961E−03 | 4.629725E−02 | 5.227239E−02 | 1.613414E−02 | −1.648304E−02 | 2.803645E−02 |
| A8 | −9.762878E−05 | −3.556265E−02 | −4.229870E−02 | −3.355393E−02 | 3.060037E−02 | −5.725790E−02 |
| A10 | −6.511320E−03 | 8.857431E−03 | 1.408895E−02 | 5.844124E−02 | −2.190835E−02 | 7.241686E−02 |
| A12 | 8.258272E−03 | 8.243164E−03 | 6.581026E−03 | −6.361296E−02 | 3.274637E−03 | −5.130470E−02 |
| A14 | −4.948341E−03 | −8.522736E−03 | −8.382101E−03 | 4.274866E−02 | 6.569378E−03 | 1.910841E−02 |
| A16 | 1.612699E−03 | 3.502094E−03 | 3.498905E−03 | −1.699085E−02 | −4.803256E−03 | −2.162340E−03 |
| A18 | −2.745124E−04 | −7.270678E−04 | −7.031838E−04 | 3.632925E−03 | 1.312491E−03 | −6.645505E−04 |
| A20 | 1.861544E−05 | 6.187914E−05 | 5.670748E−05 | −3.215323E−04 | −1.308327E−04 | 1.588688E−04 |
| | 8th Surface | 9th Surface | 10th Surface | 11th Surface | 12th Surface | 13th Surface |
| k | 0.000000E+00 | 0.000000E+00 | 0.000000E+00 | −1.453298E−01 | 0.000000E+00 | 0.000000E+00 |
| A4 | −4.310878E−02 | −4.442020E−02 | −7.794218E−02 | −7.084513E−02 | 2.840100E−02 | −2.495927E−03 |
| A6 | 3.577678E−03 | 1.093849E−02 | 4.106247E−02 | 4.817878E−02 | −7.938711E−04 | 1.600599E−02 |
| A8 | −1.137639E−02 | −8.538024E−03 | −1.886692E−02 | −2.659818E−02 | −1.323200E−02 | −9.958535E−03 |
| A10 | 1.429878E−02 | −6.772949E−03 | −1.113260E−03 | 4.890115E−03 | 8.012275E−03 | 2.421922E−03 |
| A12 | −9.548294E−03 | 1.900972E−02 | 6.983011E−03 | 3.376616E−03 | −2.663948E−03 | −2.290482E−04 |
| A14 | 1.136887E−03 | −1.666331E−02 | −4.007395E−03 | −2.487252E−03 | 5.699493E−04 | −1.649049E−05 |
| A16 | 2.054857E−03 | 7.491302E−03 | 1.008622E−03 | 6.955881E−04 | −8.141905E−05 | 6.102361E−06 |
| A18 | −1.165998E−03 | −1.747217E−03 | −1.028962E−04 | −9.298546E−05 | 6.862196E−06 | −5.527009E−07 |
| A20 | 1.949938E−04 | 1.676834E−04 | 1.259627E−06 | 4.937813E−06 | −2.455677E−07 | 1.764988E−08 |

| | 14th Surface | 15th Surface | 16th Surface | 17th Surface |
|---|---|---|---|---|
| k | 5.903476E−01 | −1.185431E−01 | −1.173044E+00 | −4.495535E+00 |
| A4 | −2.565678E−02 | −2.890259E−03 | −1.030400E−01 | −5.250256E−02 |
| A6 | 1.008131E−02 | −2.110162E−03 | 3.076946E−02 | 1.291069E−02 |
| A8 | −6.605529E−03 | −1.539020E−03 | −7.604771E−03 | −2.663763E−03 |
| A10 | 2.217489E−03 | 7.343656E−04 | 1.256558E−03 | 3.707892E−04 |
| A12 | −4.585813E−04 | −1.543847E−04 | −1.310192E−04 | −3.272823E−05 |
| A14 | 5.898935E−05 | 1.813641E−05 | 8.550800E−06 | 1.818342E−06 |
| A16 | −4.487215E−06 | −1.208867E−06 | −3.398355E−07 | −6.210966E−08 |
| A18 | 1.837032E−07 | 4.267634E−08 | 7.546170E−09 | 1.195999E−09 |
| A20 | −3.124636E−09 | −6.196976E−10 | −7.198587E−11 | −9.944462E−12 |

As illustrated in FIG. 16, the imaging lens according to Example 8 is also capable of satisfactorily correcting the aberrations.

As described above, the imaging lens according to the present embodiment is capable of allows satisfactorily correcting aberrations in spite of the small total track/diagonal ratio. The values corresponding to the conditional expressions (1) through (15) in Examples according to the present embodiment (corresponding values for conditional expressions) are listed below.

TABLE 17

| Corresponding Value for | | | | | | | | | |
|---|---|---|---|---|---|---|---|---|---|
| Conditional Expression | | Example 1 | Example 2 | Example 3 | Example 4 | Example 5 | Example 6 | Example 7 | Example 8 |
| (1) | f2/f3 | −1.144 | −1.204 | −1.117 | −1.128 | −1.419 | −1.617 | −1.382 | −1.279 |
| (2) | f3/f | 2.619 | 2.245 | 2.037 | 2.024 | 2.422 | 6.042 | 2.432 | 1.952 |
| (3) | f4/f3 | 5.595 | 9.738 | 6.469 | 6.429 | 5.494 | 1.647 | 5.540 | 33.242 |
| (4) | f34/f | 2.244 | 2.046 | 1.795 | 1.779 | 2.071 | 3.788 | 2.080 | 1.937 |
| (5) | \|f4/f5\| | 1.912 | 1.000 | 1.011 | 1.254 | 2.810 | 6.825 | 2.839 | 9.976 |
| (6) | f7/f8 | 9.676 | 9.431 | 1.620 | 1.012 | 10.616 | 1.503 | 10.552 | 1.126 |
| (7) | f8/f1 | −1.123 | −1.214 | −8.380 | −13.349 | −1.260 | −1.807 | −1.317 | −8.008 |
| (8) | f8/f | −1.303 | −1.362 | −8.004 | −12.835 | −1.339 | −1.879 | −1.405 | −7.294 |
| (9) | R3r/R5f | −0.620 | −1.984 | −3.674 | −3.500 | −0.988 | −2.579 | −1.061 | −3.876 |
| (10) | D45/D34 | 0.911 | 1.018 | 1.519 | 1.465 | 0.895 | 1.465 | 0.891 | 1.328 |
| (11) | D34/T3 | 1.000 | 0.916 | 0.976 | 1.091 | 0.975 | 0.768 | 0.984 | 0.976 |
| (12) | vd3 | 56.4 | 56.4 | 56.4 | 56.4 | 56.4 | 56.4 | 56.4 | 56.4 |
| (13) | vd6 | 55.7 | 55.7 | 55.7 | 55.7 | 37.4 | 37.4 | 37.4 | 55.7 |
| (14) | vd8 | 55.7 | 55.7 | 55.7 | 55.7 | 55.7 | 55.7 | 55.7 | 55.7 |
| (15) | \|vd7 − vd8\|/vd8 | 0.0 | 0.0 | 0.0 | 0.0 | 0.0 | 0.0 | 0.3 | 0.0 |

Therefore, when the imaging lens according to the above embodiment is applied to imaging optical systems of cameras built in portable information devices, such as smartphones, cellular phones, and portable information terminals, video game consoles, home appliances, automobiles, and the like, it is possible to achieve both greater functionality and miniaturization of the cameras.

The present invention is applicable to an imaging lens assembled into relatively small-sized cameras to be built in portable information devices, such as smartphones, medical devices, video game consoles, home appliances, automobiles, and the like.

### DESCRIPTION OF REFERENCE NUMERALS

X: optical axis
ST: aperture stop
L1: first lens
L2: second lens
L3: third lens
L4: fourth lens
L5: fifth lens
L6: sixth lens
L7: seventh lens
L8: eighth lens
IR: filter
IM: image plane

What is claimed is:

1. An imaging lens for forming an image of an object on an image sensor comprising: in order from an object side to an image side,
a first lens having positive refractive power;
a second lens having negative refractive power;
a third lens having positive refractive power;
a fourth lens having positive refractive power;
a fifth lens;
a sixth lens;
a seventh lens having negative refractive power; and
an eighth lens having negative refractive power,
wherein an object-side surface of the sixth lens is concave in a paraxial region, and an object-side surface of the eighth lens is convex in the paraxial region.

2. The imaging lens according to claim 1, wherein a conditional expression (1) below is satisfied:
−3.0<f2/f3<−0.2 (1)
where
f2: a focal length of the second lens, and
f3: a focal length of the third lens.

3. The imaging lens according to claim 1, wherein a conditional expression (2) below is satisfied:
1.0<f3/f<8.0 (2)
where
f: a focal length of entire optical system of the imaging lens, and
f3: a focal length of the third lens.

4. The imaging lens according to claim 1, wherein a conditional expression (3) below is satisfied:
1.0<f4/f3<35.0 (3)
where
f3: a focal length of the third lens, and
f4: a focal length of the fourth lens.

5. The imaging lens according to claim 1, wherein a conditional expression (4) below is satisfied:
1.0<f34/f<6.0 (4)
where
f: a focal length of entire optical system of the imaging lens, and
f34: a composite focal length of the third lens and the fourth lens.
